(19) United States
(12) Patent Application Publication
(10) Pub. No.: US 2009/0153650 A1
(43) Pub. Date: Jun. 18, 2009

(54) CAMERA POSITION RECOGNITION SYSTEM

(75) Inventors: Takeshi MISAWA, Kurokawa-gun (JP); Mikio Watanabe, Kurokawa-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/141,534

(22) Filed: Jun. 18, 2008

(30) Foreign Application Priority Data
Jun. 18, 2007 (JP) 2007-160117

(51) Int. Cl. H04N 13/02

(52) U.S. Cl. 348/48; 348/E13.074

(57) ABSTRACT

A camera position recognition system includes: multiple cameras removably placed at different positions to be able to photograph a subject from different viewpoints along a horizontal direction; a host device to assign camera identification information to each camera, the camera identification information representing a relative position of each camera; and a marker member placed at a position of the subject and to be photographed by the cameras. The marker member presents different shapes in images photographed by the cameras depending on the position of each camera. The host device acquires the images of the marker member photographed by the cameras and determines the camera identification information based on differences between the shapes of the marker member captured in the images.

### BACKGROUND OF THE INVENTION

1. Field of the Invention

The present invention relates to a camera system including multiple cameras, and in particular to a camera position recognition system to recognize positions of the cameras.

2. Description of the Related Art

In recent years, various camera systems with multiple cameras have been proposed. Among such camera systems, a camera system for 3D (three-dimensional) photographing has multiple cameras disposed around a three-dimensional subject, for example. Pieces of image data photographed by the respective cameras are integrated into a single lenticular print to generate a 3D image, which can provide a stereoscopic view.

As another example, a remote camera system has been proposed, which provides, via a network, images taken through cameras set at remote positions. In this remote camera system, multiple cameras are connected to the system, and pieces of image data acquired by all of the cameras are displayed on a single monitor, to allow the user to view an image taken through a desired camera that is displayed in a size different from other images so that the user can easily recognize the image taken through the desired camera (Japanese Unexamined Patent Publication No. 2004-112771).

In a case where a serial bus-type transmission interface, such as USB cables, is used to connect the cameras to a host device for transmission of image data from the cameras in the above-described camera systems using multiple cameras, however, the cameras are recognized usually in the order in which the individual USB cables are connected to a communication software application in the host device, and initial IDs are assigned to the cameras in the order of the recognition. Therefore, there is no correlation between the camera IDs and locations of the cameras.

Further, although an image of a desired camera can be recognized in the above-mentioned remote camera system disclosed in Japanese Unexamined Patent Publication No. 2004-112771, it is difficult to recognize the location of each camera.

In a case where the 3D image is generated, the host device has to arrange multiple images acquired with the multiple cameras in an appropriate order. In this case, if the positions of the cameras are unclear, the order of the images to be combined cannot readily be determined, and it may be impossible to obtain a highly accurate 3D image. Therefore, such conventional camera systems necessitate operations to allow the host device to identify the position of each camera, such as by shielding the lenses of the cameras one by one, and this is extremely inconvenient.

### SUMMARY OF THE INVENTION

In view of the above-described circumstances, the present invention is directed to providing a camera position recognition system that can easily and reliably identify the position of each camera.

The camera position recognition system of the invention includes: a plurality of cameras removably placed at different positions to be able to photograph a subject from different viewpoints along a horizontal direction; a host device to assign camera identification information to each camera, the camera identification information representing a relative position of each camera; and a marker member placed at a position of the subject and to be photographed by the cameras, wherein the marker member presents different shapes in images photographed by the cameras depending on the position of each camera, and the host device acquires the images of the marker member photographed by the cameras and determines the camera identification information based on differences between the shapes of the marker member captured in the images.

The position of the marker member being “placed at a position of the subject” may not be the exact position where the subject is placed, as long as the marker member is placed in the photographing direction of each camera, and may, for example, be a position in front of the subject.

The “marker member” may, for example, be a three-dimensional object, or a figure drawn on a plane, such as a wall, plate or a sheet of paper. Such a three-dimensional object or a figure may be printed, or may be electronically displayed with, for example, LEDs.

In the camera position recognition system of the invention, the marker member may have right and left ends perpendicular to the horizontal direction, and the host device may determine the camera identification information based on values of length ratios of vertical lengths of the right and left ends of the marker member in the images photographed by the cameras.

In this case, the host device may determine identification information specifying a main camera among the cameras, which is one of the cameras that has photographed an image with a length ratio of the vertical lengths of the right and left ends that is nearest to an average of the values of the length ratios in the images of the marker member photographed by the cameras.

In the camera position recognition system of the invention, the marker member may have a portion with a largest or smallest vertical length in addition to the right and left ends in the horizontal direction, and the host device may determine the camera identification information based on values of distance ratios of distances from the right and left ends of the marker member to the portion with the largest or smallest vertical length in the images photographed by the cameras.

In this case, host device may determine identification information specifying a main camera among the cameras, which is one of the cameras that has photographed an image with a distance ratio that is nearest to an average of the values of the distance ratios in the images of the marker member photographed by the cameras.

### BRIEF DESCRIPTION OF THE DRAWINGS

FIG. 1 is a diagram illustrating the schematic configuration of a camera position recognition system,

FIG. 2 is an enlarged view of a marker member,

FIG. 3 illustrates an example of screens displayed before and after camera IDs are rearranged by a host device,

FIG. 4 is a flow chart of a process for detecting the order of camera viewpoints,

FIG. 5 is a flow chart of a process for detecting lengths of straight lines,

FIG. 6 illustrates one example of an image of the marker member photographed by one of cameras,

FIG. 7 is an enlarged view of a marker member according to a second embodiment,

FIG. 8 is a flow chart of a process for detecting lengths of straight lines shown in FIG. 7,

FIG. 9 illustrates one example of an image of the marker member of FIG. 7 photographed by one of the cameras,

FIG. 10 illustrates one example of an image of another marker member photographed by one of the cameras,

FIG. 11A is an enlarged view of a marker member according to a third embodiment, and

FIG. 11B is an enlarged view of a marker member according to a fourth embodiment.

### DESCRIPTION OF THE PREFERRED EMBODIMENTS

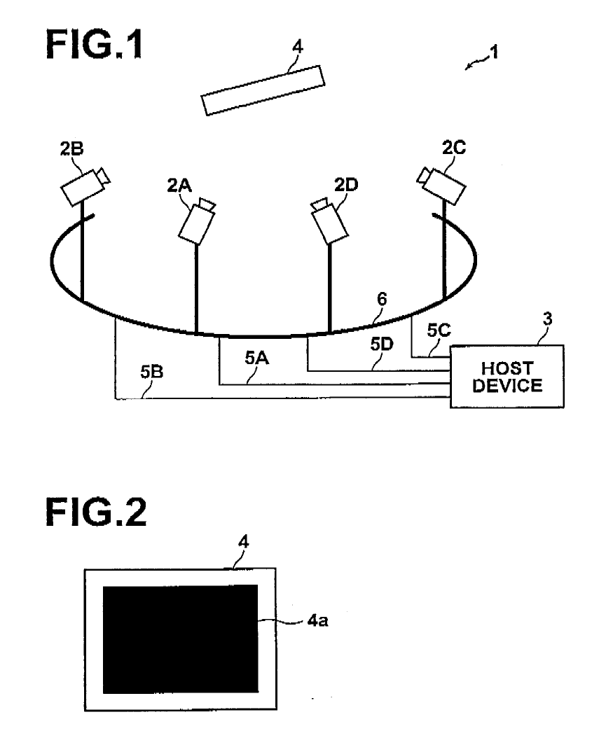

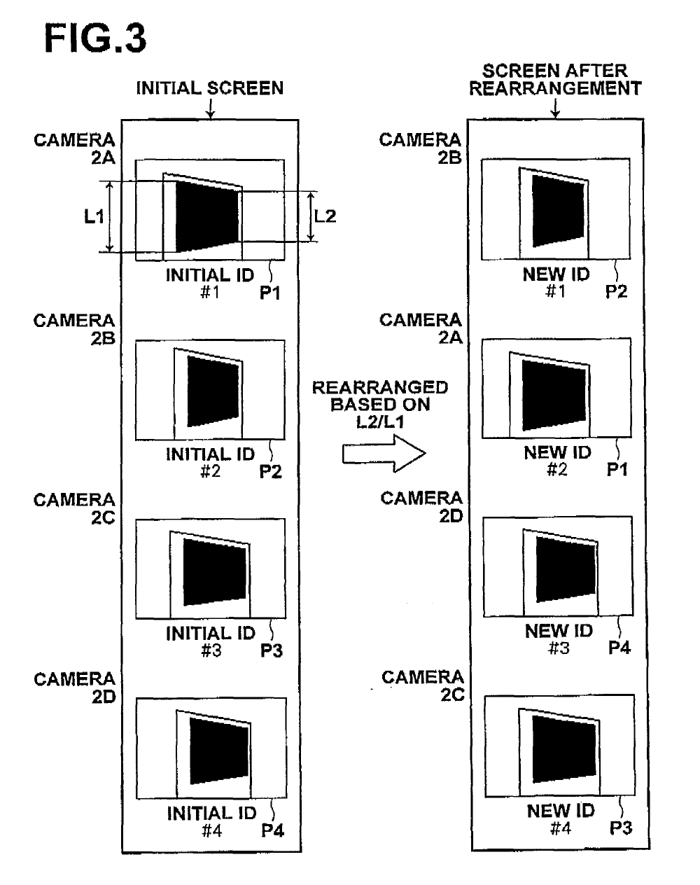

Hereinafter, a camera position recognition system 1 according to one embodiment of the present invention will be described in detail with reference to the drawings. FIG. 1 illustrates the schematic configuration of the camera position recognition system 1, FIG. 2 is an enlarged view of a marker member 4a shown in FIG. 1, and FIG. 3 shows an example of screens to be displayed on the host device before and after camera IDs are rearranged.

As shown in FIG. 1, the camera position recognition system 1 of this embodiment includes: four cameras 2A-2D which are removably set on a fixing mount 6; a host device 3; and a display member 4 displaying a marker member 4a. The cameras 2A-2D are respectively connected to the host device through USB cables 5A-5D, which serve as a transmission interface, via a hub (not shown). The transmission interface may be a serial bus interface (such as USB cables), or LAN cables or wireless LAN, for example.

As shown in FIG. 1, the four cameras 2A-2D are mounted on the fixing mount 6 with arbitrary intervals therebetween along the horizontal direction (transverse direction), so that the cameras can photograph a subject (not shown) from different viewpoints to provide a stereoscopic view of the subject. The symbols A, B, C and D respectively assigned to the cameras 2 represent hardware numbers of the cameras, which were uniquely assigned to the cameras when they were manufactured.

The host device 3 is formed, for example, by a PC (personal computer) with a monitor, a keyboard, a mouse, and the like. The host device 3 has a function to assign the camera IDs (camera identification information), which represent relative positions of the four cameras 2A-2D, to the individual cameras 2. Detection of the relative positions of the cameras 2A-2D will be described later in detail.

The display member 4 has a rectangular parallelepiped shape. As shown in FIG. 1, a surface of the display member 4 having a predetermined area is disposed to be perpendicular to the horizontal direction and to be seen from the four cameras 2A-2D. In this embodiment, the surface is angled to either of the optical axis directions of the cameras 2A-2D.

As shown in FIG. 2, the surface of the display member 4 visible from the cameras 2A-2D is provided with the marker member 4a printed thereon. The marker member 4a is formed by a rectangle area containing multiple straight lines extending in the vertical direction. The marker member 4a presents different shapes to different viewpoints. The different shapes presented by the marker member 4a will be described later in detail.

The marker member 4a may not necessarily be printed on the surface of the display member 4, as long as it can be displayed on the surface. For example, a sheet of paper with the marker member 4a printed thereon may be adhered to the surface of the display member 4, or a light image of the marker member 4a may be projected on the surface of the display member 4. Alternatively, the marker member 4a may be displayed using light emitting devices.

In the camera recognition system 1 having the above-described configuration, when the cameras 2A-2D are powered on, the host device 3 recognizes the hardware numbers of the cameras 2A-2D in the order in which the individual USB cables 5A-5D are connected to a communication software application in the device 3, and assigns initial IDs #1-#4 to the cameras in the order of the recognition (see the left portion of FIG. 3).

Then, the host device 3 rearranges the initial IDs of the cameras in the order of the viewpoints of the cameras and assigns to the cameras new camera IDs, which represent the relative positions of the cameras 2A-2D. The assignment of the new camera IDs is carried out when a camera viewpoint order detection mode is selected on the host device 3. In order to detect the order of the viewpoints of the cameras, first, the display member 4, or the marker member 4a, is placed at a position of a subject, as shown in FIG. 1.

The position of the marker member 4a may not be the exact position where the subject is placed, as long as right and left ends of the marker member 4a can be contained in fields of view of the cameras 2A-2D, and may, for example, be a position in front of the already-placed subject.

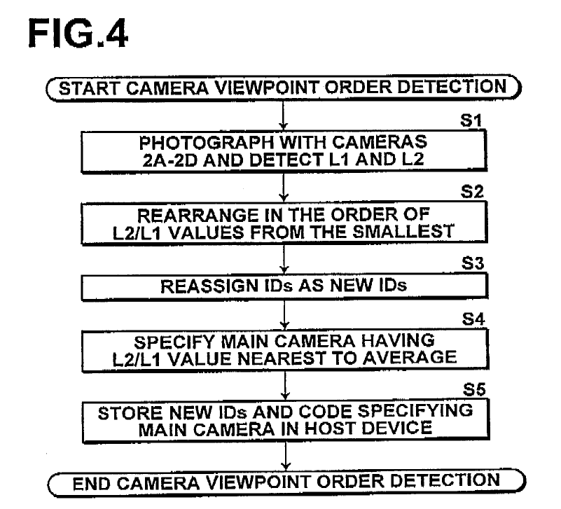

Now, a process for detecting the order of the viewpoints of the cameras will be described in detail. FIG. 4 is a flow chart of the camera viewpoint order detection process. As shown in FIG. 4, first, the four cameras 2A-2D respectively photograph the marker member 4a according to an instruction sent from the host device 3. Then, the host device 3 acquires images of the marker member 4a photographed by the respective cameras 2A-2D via the USB cables 5A-5D, and displays the acquired images, which are arranged in the order of the initial IDs #1-#4 of the cameras, on the screen, as shown at the left portion in FIG. 3. Here, the images photographed by the cameras are respectively referred to as images P1-P4 correspondingly to the initial IDs #1-#4 of the cameras.

Since the images P1-P4 are obtained with the four cameras 2A-2D by photographing the marker member 4a displayed on the display member 4 from different viewpoints, the shape of the marker member 4a captured in the images P1-P4, specifically, for example, lengths of the vertical straight lines, a horizontal length of the area containing the straight lines, and angles of a line connecting the upper ends of the straight lines and a line connecting the lower ends of the straight lines with respect to the horizontal direction, varies between the images P1-P4 depending on the position (viewpoint) of each of the cameras 2A-2D, as shown at the left portion in FIG. 3.

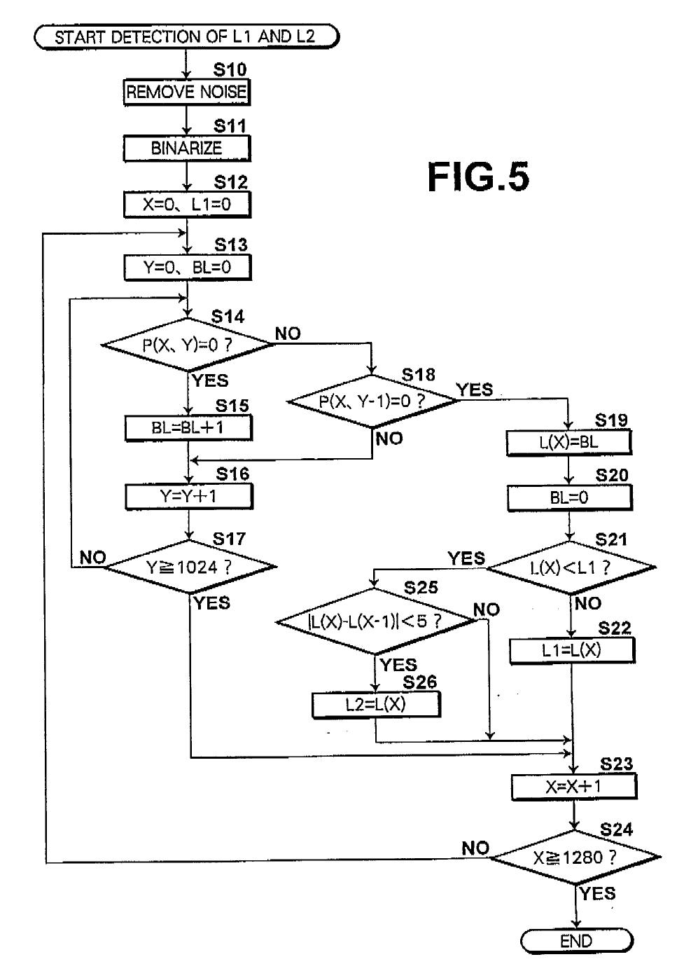

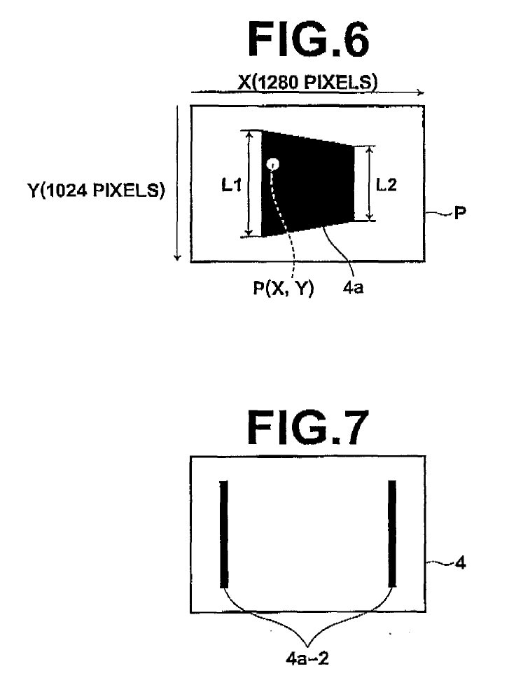

Therefore, the host device 3 detects a vertical length L1 of the left end of the marker member 4a and a vertical length L2 of the right end of the marker member 4a, as shown at the left portion in FIG. 3, from each of the acquired images P1-P4 (step S1). FIG. 5 is a flow chart of a process for detecting the lengths L1 and L2, and FIG. 6 shows one example of the image of the marker member 4a photographed by one of the cameras. In FIG. 6, it is assumed that the upper left corner of the image P is the origin, the transverse direction is the X axis, the longitudinal direction is the Y axis, and the number of pixels forming the image P is 1280 pixels along the X axis and 1024 pixels along the Y axis.

As shown in FIG. 5, in the detection of the lengths of right and left ends L1, L2 by the host device 3, first, noise is removed from the image P with, for example, low-pass filtering or isolated point removal (step S10). Then the image P is binarized using a threshold, which is an average of all the pixel values P(X,Y) of the image shown in FIG. 6, such that a value of “255” is assigned to pixels having values higher or equal to the threshold, and a value of “0” is assigned to pixels having values less than the threshold, to convert the image P into a black and white image (step S11). The “X,Y” represents coordinates in the image P.

Then, a value of 0 is assigned to X and the left end length of L1 (step S12), and further a value of 0 is assigned to Y and EL, which is a counter, for initialization (step S13).

Then, the following operations are carried out to scan the image from the origin in the positive direction along the Y axis (downward) with shifting the scanning line one by one (pixel) in the positive direction along the X axis (rightward), in order to detect the vertical length L by detecting an edge (the lower end of each line) between the black pixels and the white pixels in the image shown in FIG. 6-Since the image shown in FIG. 6 is obtained by photographing the marker member 4a which is disposed such that the right side (on the drawing) thereof is farther from the camera 2 than the left side, the portion having the longest vertical length L is the left end and the portion having the shortest vertical length L is right end.

First, the host device 3 determines whether or not the pixel value P(X,Y) is 0, i.e., whether or not the pixel is a black pixel (step S14). If the pixel value P(X,Y) is 0, i.e., the pixel is a black pixel (step S14: YES), then, BL is counted up to count the number of black pixels as the length of the line (step S15). Then, Y is counted up (step S16), and determination is made as to whether or not Y has reached 1024 pixels (step S17).

If Y has not reached 1024 pixels (step S17: NO), the process proceeds to step S14, and further scanning is carried out in the Y direction. In contrast, if Y has reached 1024 pixels (step S17; YES), this means that an edge between black pixels and white pixels has not been detected along the Y direction at the current coordinate value X, that is, the lower end of the line has not been detected by the current scanning of the image P in the Y direction, and the process proceeds to step S23.

Then, X is counted up, i.e., the scanning line is shifted by one pixel in the X direction (step S23), and determination is made as to whether or not X has reached 1280 pixels (step S24). If X has not reached 1280 pixels (step S24: NO), then, the operations in step S13 and the following steps are repeated until X reaches 1280 pixels, that is, until the scanning of the image P is completed in the X direction.

In contrast, if X has reached 1280 pixels (step S24: YES), this means that the scanning of the image P has been completed in the X direction, i.e., the entire image P has been scanned, and the process ends without detecting the edges at the upper and lower ends.

In contrast, if it is determined in step S14 that the pixel value P(X,Y) is not 0, i.e., the pixel is a white pixel (step S14: NO), determination is made as to whether or not a previous pixel value P(X,Y−1) along the Y direction is 0, i.e., whether or not the previous pixel is a black pixel (step S18). If the previous pixel value P(X,Y−1) is not 0, i.e., the previous pixel is a white pixel (step S18: NO), this means that an edge between black pixels and white pixels, i.e., the lower end of the line has not been detected, and the process proceeds to step S16 to carry out further scanning along the Y direction. It should be noted that, if Y is the initial value, i.e., 0, “Y−1” in step S18 is set as “Y”.

If it is determined in step S18 that the pixel value P(X,Y−1) is 0, i.e., the pixel is a black pixel (step S18: YES), this means that an edge between black pixels and white pixels, i.e., the lower end of the line has been detected. Then, the current value of BL is assigned to L (X) (step S19), and a value of 0 is assigned to BL (step S20).

Then, determination is made as to whether or not L (X) is smaller than L1 (step S21). Since the marker member 4a in this example is disposed such that the length L1 is the longest, as shown in FIGS. 3 and 6, if L(X) is larger than L1 (step S21: NO), then, the current value of L(X) is assigned to L1 (step S22) so that L1 has the largest value.

Then, X is counted up, i.e., shifted by one pixel along the X direction (step S23), and determination is made as to whether or not X has reached 1280 pixels (step S24). If X has not reached 1280 pixels (step S24: NO), the operations in step S13 and the following steps are repeated until X reaches 1280 pixels, i.e. the scanning of the image P is completed along the X direction.

In contrast, if it is determined in step S21 that L(X) is smaller than L1 (step S21: YES), a difference between L(X) and L(X−1), which is the length of the line detected at the previous position (one pixel before) along the X direction, is recognized (step S25). If the difference is, for example, within five pixels (step S25: YES), this means that the value of the length L2 is a reliable value, i.e., the right and left ends of the marker member 4a are not angled with respect to the Y direction, and the current value of L(X) is assigned to L2 (step S26). This operation is carried out so that the length L2, which is the shortest when the marker member 4a is disposed in the manner as shown in FIGS. 3 and 6, does not have an erroneous small value in such a case where the right and left ends of the marker member 4a are angled with respect to the Y direction. Then, the process proceeds to step S23.

In contrast, if it is determined in step S25 that the difference is not within five pixels (step S25: NO), there is a possibility that the right and left ends of the marker member 4a are angled with respect to the Y direction. Therefore, the current value of L(X) is not assigned to L2 and the process proceeds to step S23.

Then, X is counted up, i.e., shifted by one pixel along the X direction (step S23), and determination is made as to whether or not X has reached 1280 pixels (step S24). If X has not reached 1280 pixels (step S24: NO), the operations in step S13 and the following steps are repeated until X reaches 1280 pixels, i.e., until the scanning of the image P is completed along the X direction.

If X has reached 1280 pixels (step S24: YES), this means that the scanning of the image P has been completed along the X direction, i.e., the entire image P has been scanned, and the process for detecting the lengths L1, L2 ends. In this manner, the lengths L1, L2 of the right and left ends of the marker member 4a are detected from each of the images P1-P4.

As shown in FIG. 4, as the host device 3 detects the lengths L1, L2 of the right and left ends of the marker member 4a from each of the images P1-P4, as described above (step S1), a length ratio L2/L1 of the detected lengths L1, L2 of the right and left ends is calculated for each of the images P1-P4. Then, the images P1-P4 are rearranged in the order of the value of the calculated length ratio from the smallest (step S2).

Specifically, as shown at the left portion in FIG. 3, if, for example, the detected length L1 of the left end is “670” and the detected length L2 of the right end is “473” in the image P1, the length ratio L2/L1 calculated by the host device 3 is “0.706”. Similarly, it is assumed that the length ratio L2/L1 detected by the host device 3 is “0.684” for the image P2, “0.723” for the image P3, and “0.714” for the image P4, for example.

Then, the images P1-P4 are rearranged in the order of the length ratios L2/L1, i.e., “0.684”, “0.706”, “0.714” and “0.723”, and the rearranged order of the images P1-P4 is: the image P2, the image P1, the image P4 and the image P3, as shown at the right portion in FIG. 3.

This means that the four cameras 2A-2D are arranged in the order of the camera 2B, the camera 2A, the camera 2D and the camera 2C which photographed the image P2, the image P1, the image P4 and the image P3, respectively. Therefore, the new IDs #1-#4 are assigned to the cameras in this order (step S3).

At this time, the host device 3 associates the hardware numbers (A, B, C, D) of the cameras 2A-2D with the new camera IDs #1-#4 and stores them. In this manner, when the host device 3 is restarted without changing the positions of the cameras 2A-2D, the stored hardware numbers and new IDs are read out, so that it is not necessary to carry out the above described camera viewpoint order detection process again.

The user may wish to assign the new IDs #1-#4 in the order of the positions of the cameras shown in FIG. 1 from the left or from the right, or may wish to use letters or symbols to indicate the order of the viewpoints. Therefore, various patterns may be prepared for assignment of the new IDs, and the pattern selected by each user may be stored in the host device 3, so that the user can download his or her own IDs to display them on the display screen of the host device 3 together with the images taken through the cameras.

Further, the host device 3 calculates an average (“0.707” in this example) of the length ratios L2/L1 in the images P1-P4 detected in step S2 (“0.684”, “0.706”, “0.714” and “0.723” in this example), and specifies one of the cameras (the camera 2A in this example) which photographed the image (P1 in this example) having the value of the length ratio L2/L1 (“0.706”) nearest to the average (“0.707”), as a main camera (step S4).

If the average is, for example, “0.71”, which is a central value between the length ratios L2/L1 of “0.706” and “0.714”, then either of the camera 2A, which photographed the image P1 having the length ratio of “0.706”, or the camera 2D, which photographed the image P4 having the length ratio of “0.714”, may be specified as the main camera. For such a case, information of a dominant eye of the user, for example, may be stored in the host device 3, and it the dominant eye of the user is the right eye, one of the two cameras nearer to the right side (as viewed in FIG. 1) may be specified as the main camera.

Then, the host device 3 stores the new camera IDs assigned as described above and a code specifying the main camera (step S5). In this manner, the camera viewpoint order detection process is carried out.

According to the above-described camera position recognition system 1 of this embodiment, the marker member 4a photographed by the cameras 2A-2D presents different shapes in the photographed images depending on the positions of the cameras 2A-2D. Therefore, the relative positions of the cameras 2A-2D can be recognized based on the differences of the shape. To achieve this, the host device 3 acquires the images P1-P4 of the marker member 4a photographed by the respective cameras 2A-2D, and determines the new camera IDs representing relative positions of the cameras 2A-2D based on the differences of the shape of the marker member 4a captured in the images P1-P4, to assign the new camera IDs to the cameras.

Since the positions of the cameras 2A-2D can easily and reliably be recognized by simply placing the marker member 4a in the fields of view of the cameras 2A-2D, the host device 3 needs not to check the positional order of the acquired images P1-P4, and this facilitates generation of a 3D image.

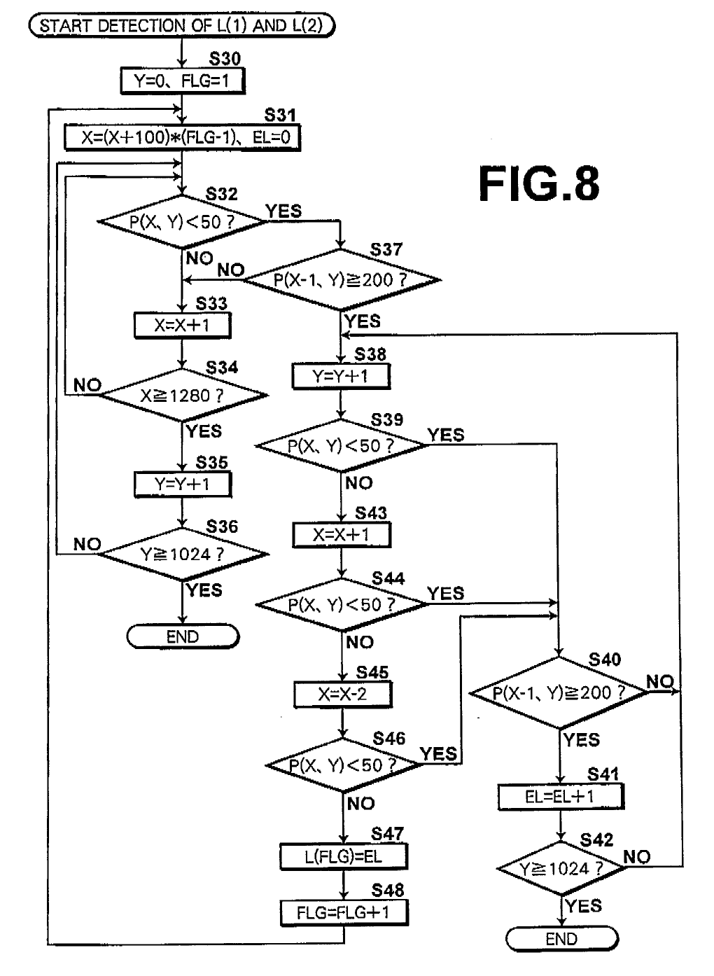

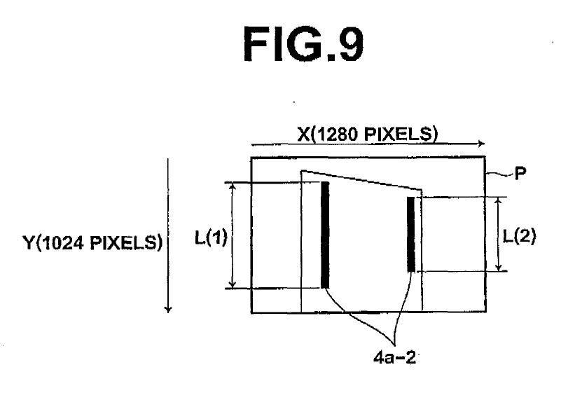

It should be noted that, although the marker member 4a has a rectangular shape formed by multiple straight lines extending in the vertical direction in this embodiment, this is not intended to limit the invention. FIG. 7 shows a marker member 4a-2 according to a second embodiment of the invention in enlarged view, FIG. 8 shows a flow chart of a process for detecting the lengths L1, L2 of the marker member 4a-2 shown in FIG. 7, and FIG. 9 shows one example of an image of the marker member 4a-2 photographed by one of the cameras.

As shown in FIG. 7, the marker member 4a-2 of this embodiment is formed by two straight lines extending in the vertical direction Now, the process for detecting the vertical lengths of the right and left ends of the marker member 4a-2, i.e., the length L1 of the straight line at the left and the length L2 of the straight line at the right, will be described.

In FIG. 9, it is assumed that the upper left corner of the image P is the origin, the transverse direction is the X axis, the longitudinal direction is the Y axis, and the number of pixels forming the image P is 1280 pixels along the X axis and 1024 pixels along the Y axis. The “X, Y” represents coordinates in the image P. In a case where the host device 3 operates in the 8-bit color mode, in which 8-bit color information is assigned to each pixel, pixels of the image shown in FIG. 9 having a signal level of the pixel value P (X,Y) of less than 50 are “black” pixels, and those having a signal level of the pixel value P(X,Y) of 200 or more are “white” pixels. The camera viewpoint order detection process of this embodiment is the same as that in the above-described embodiment shown in FIG. 4, and therefore explanation thereof is not repeated.

The host device 3 carries out the following operations to detect each straight line by scanning the image P shown in FIG. 9 in the positive direction along the X axis and detecting an edge between white pixels and black pixels, i.e., the left end of the straight line, and when each straight line is detected, to detect the vertical length L of the line by scanning the image in the positive direction along the Y axis and detecting an edge between black pixels and white pixels, i.e., the lower end of the line.

As shown in FIG. 8, in the detection of the lengths L1, L2 of the left and right straight lines by the host device 3, first, a value of 0 is assigned to Y and a value of 1 is assigned to FLG (flag) (step S30). Then, a current value of (X+100)*(FLG−1) is assigned to X and a value of 0 is assigned to EL, which is a counter, so that X is set to 0 and FLG is set to 1 for initialization at the first time, and then, at the second time and later, X is shifted from the final value of X by 100 pixels in the positive direction along the X axis and this point is set as the initial value (step S31).

Then, determination is made as to whether or not P(X,Y) is less than 50, i.e., whether or not the pixel is a black pixel (step S32). If the pixel is not a black pixel (step S32: NO), then, X is counted up (step S33), and determination is made as to whether or not X has reached 1280 pixels (step S34). If X has not reached 1280 pixels (step S34: NO), then, the operations in step S32 and the following steps are repeated until X reaches 1280 pixels, i.e., until the scanning of the image P is completed along the X direction.

In contrast, if it is determined in step S34 that X has reached 1280 pixels (step S34: YES), this means that the scanning of the image P has been completed along the x direction, and Y is counted up, i.e., shifted by one pixel in the positive direction along the Y axis (step S35). Then, determination is made as to whether or not Y has reached 1024 pixels (step S36). If Y has not reached 1024 pixels (step S36: NO), then, the operations in step S32 and the following steps are repeated until Y reaches 1024 pixels, i.e., until the scanning of the image P is completed along the Y direction.

In contrast, if it is determined in step S36 that Y has reached 1024 pixels (step S36: YES), this means that the scanning of the image P has been completed along the Y axis direction without detecting a black pixel, i.e., without detecting the straight line through the operations in steps S32 to S36, and the process ends.

In contrast, if it is determined in step S32 that P(X,Y) represents a black pixel (step S32: YES), then, determination is made as to whether or not P(X−1,Y) is 200 or more, i.e., the pixel value P (X−1, Y) of the previous pixel along the X direction represents a white pixel (step S37).

If P(X−1,Y) dose not represent a white pixel (step S37, NO), this means that an edge between white pixels and black pixels, i.e., the left end of the straight line has not been detected, and the process proceeds to step S33 to continue the scanning along the X direction. In contrast, if P(X−1,Y) represents a white pixel (step S37: YES), this means that an edge between white pixels and black pixels, i.e., the left end of the straight line has been detected, and Y is counted up (step S38) to detect an edge at a position one pixel below the detected edge at the current coordinate value X. Then, determination is made as to whether or not P (X,Y) is less than 50, i.e., whether or not the pixel is a black pixel (step S39).

If the pixel is a black pixel (step S39: YES), then, determination is made as to whether or not the pixel value P(X−1,Y) of the previous pixel along the X direction is 200 or more, i.e., whether or not it represents a white pixel (step S40). If P(X−1,Y) represents a white pixel (step S40: YES), this means that an edge between white pixels and black pixels has been detected at a position one pixel below, i.e., the straight line serving as the marker member 4a is not angled. Then, EL is counted up (step S41), and determination is made as to whether or not Y has reached 1024 pixels (step S42).

If Y has not reached 1024 pixels (step S42. NO), the operations in step S38 and the following steps are repeated until Y reaches 1024 pixels, i.e., until the scanning of the image P is completed along the Y direction. If Y has reached 1024 pixels (step S52: YES), this means that scanning of the image P has been completed along the Y direction, and the process ends.

If it is determined in step S40 that P (X−1,Y) does not represent a white pixel (step S40: NO), this means that an edge between white pixels and black pixels has not been detected at a position one pixel below along the Y direction, i.e., the straight line serving as the marker member 4a may possibly be angled. Then, the process proceeds to step S38 to detect an edge at a position one pixel below from the previous position.

In contrast, if it is determined in step S39 that P(X,Y) does not represent a black pixel (step S39: NO), this means that the straight line serving as the marker member 4a is angled. Then, in order to detect an edge at a position shifted by one pixel in both the positive and negative directions along the X direction, first, X is counted up (step S43), and determination is made as to whether or not P(X,Y) is less than 50 at the position shifted by one pixel in the positive direction along the X axis, i.e., whether or not the pixel is a black pixel (step S44).

If the pixel is a black pixel (step S44; YES), the process proceed to step S40, and determination is made as to whether or not the pixel value P (X−1,Y) of the previous pixel along the X direction represents a white pixel (step S40) to detect an edge between black pixels and white pixels.

If P(X,Y) does not represent a black pixel (step S44: NO), a current value of X−2 is assigned to X (step S45) to shift the position by one pixel in the negative direction along the X axis from the coordinate value X at step S39, and determination is made as to whether or not P(X,Y) is less than 50, i.e., whether or not it represents a black pixel at the position shifted by one pixel from the position at step S39 (step S46). If P(X,Y) represents a black pixel (step S46: YES), then, the process proceeds to step S40, and determination is made as to whether or not the pixel value P (X−1, Y) of the previous pixel along the X direction represents a white pixel (step S40) to detect an edge between black pixels and white pixels.

If it is determined in step S46 that P (X,Y) does not represents a black pixel (step S46: NO), this means that a black pixel has not been detected at the position shifted by one pixel in both the positive and negative directions along the X direction, i.e., the lower end of the straight line has been detected. Then, the current value of EL is assigned to L(FLG) (step S47) to detect the length L1 of the straight line, and FLG is counted up (step S48) to detect the length L2 of the straight line at the right. Then, the process proceeds to step S31, where the position of X is shifted by 100 pixels in the positive direction along the X axis from the current X position, and this position is set as the initial value. Then, the operations in step S31 and the following steps are repeated. In this manner, the lengths L1 and L2 of the left and right straight lines are detected.

In the above-described embodiment, a signal level of F(X,Y) of less than 50 is determined as representing a “black” pixel and a signal level of P(X,Y) of 200 or more is determined as representing a “white” pixel in the flow chart shown in FIG. 8. These thresholds are determined so as to prevent erroneous detection. These thresholds may be found based on a histogram of the entire image, for example, to improve the accuracy.

In the above-described embodiment, when a “white” pixel is detected next to a detected “black” pixel along the X direction, the boundary between the “white” and “black” pixels is determined as the edge. However, in some cases, the edge may be blurred by image processing, and the “white” pixel next to the “black” pixel may have a signal level value of 500 or more and less than 200. In such a case, accuracy of the detection can be improved by detecting whether or not a second pixel from the detected “black” pixel along the X direction is a “white” pixel.

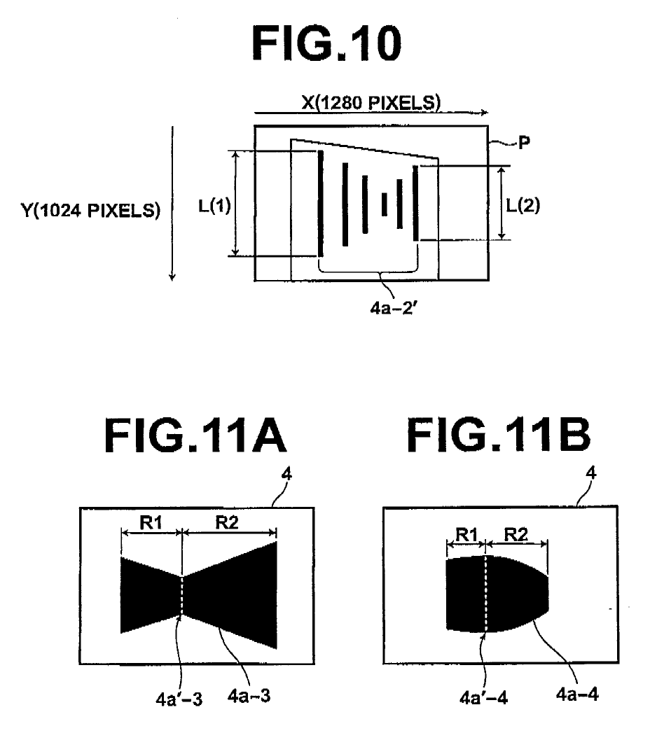

It should be noted that, in the flow chart shown in FIG. 8, the length L is defined as a sequence data L(1), L(2), . . . , L(N) (wherein N is a total number of the straight lines). Therefore, this process is also applicable to a marker member 4a-2′, as shown in FIG. 10, which is formed by multiple straight lines. If the marker member is formed, for example, by straight lines arranged with a small interval therebetween in the horizontal direction, like the marker member 4a, the number of pixels by which X is shifted in the positive direction along the X axis in step S31 may be reduced to tailor the process to various forms of the marker member 4a.

Next, a marker member 4a-3 according to a third embodiment of the invention and a marker member 4a-4 according to a fourth embodiment of the invention will be described. FIG. 11A is an enlarged view of the marker member 4a-3 and FIG. 11B is an enlarged view of the marker member 4a-4.

As shown in FIG. 11A, the marker member 4a-3 of the third embodiment is formed by multiple straight lines extending in the vertical direction, and has right and left ends, and a portion 4a′-3 having the smallest vertical length between the right and left ends. With the marker member 4a-3 having such a shape, the new camera IDs may be determined based on values of ratios of the vertical lengths of the right and left ends captured in the respective images taken by the cameras similarly to the above-described embodiment. However, as shown in FIG. 11A, the new camera IDs can also be determined based on values of distance ratios R2/R1 of a distance R1 from the left end to the smallest portion 4a′-3 and a distance R2 from the right end to the smallest portion 4a′-3 captured in the respective images taken by the cameras.

In this case, the vertical length of the small portion 4a′-3 is detected according to the process of the flow chart shown in FIG. 8, in which the lengths L(N) of all the straight lines extending in the vertical direction are detected, and a straight line having the smallest length among the detected lengths L(N) is determined as being the smallest portion 4a′-3. Then, the distances R1 and R2 are calculated from an X coordinate value at which the straight line of the smallest portion 4a′-3 is detected and X coordinate values at which the straight lines of the right and left ends are respectively detected, to calculate the distance ratio R2/R1.

In this case, the host device 3 calculates an average of the distance ratios R2/R1 respectively found in the images P1-P4 of the marker member 4a-3 photographed by the cameras 2, and specifies one of the cameras 2 that has photographed the image P having the distance ratio R2/R1 nearest to the average as the main camera.

As shown in FIG. 11B, the marker member 4a-4 of the fourth embodiment is formed by multiple straight lines extending in the vertical direction, and has right and left ends, and a portion 4a′-4 having the largest vertical length between the right and left ends. Similarly to the marker member 4a-3 of the above-described embodiment, with the marker member 4a-4 having such a shape, lengths L(N) of all the straight lines extending in the vertical direction are detected according to the process of the flow chart shown in FIG. 8, and a straight line having the largest length among the detected lengths L (N) is determined as being the largest portion 4a′-4. Then, the distances R1 and R2 are calculated from an X coordinate value at which the straight line of the largest portion 4a′-4 is detected and X coordinate values at which the straight lines of the right and left ends are respectively detected, to calculate the distance ratio R2/R1.

Similarly to the third embodiment, the host device 3 calculates an average of the distance ratios R2/R1 respectively found in the images P1-P4 of the marker member 4a-4 photographed by the cameras 2, and specifies one of the cameras 2 that has photographed the image P having the distance ratio R2/R1 nearest to the average as the main camera.

It should be noted that, although the multiple cameras 2 are mounted on the single fixing mount 6 in the camera position recognition system of the above-described embodiments, this is not intended to limit the invention. For example, more than one fixing mounts 6 may be used, as long as the multiple cameras 2 can be removably fixed at predetermined positions.

Further, although the four cameras are used in the above-described embodiments, this is not intended to limit the invention. As long as more than one cameras are used, any number of cameras, such as six or nine cameras, may be used.

The multiple cameras may be set along the same plane, and may be able to photograph the subject along the plane.

The marker member 4a of the invention is not limited to those described in the above embodiments. As long as the marker member 4a can present different shapes in images photographed by the cameras disposed at different positions, the marker member may, for example, be a three-dimensional object, or a figure drawn on a plane, such as a wall, plate or a sheet of paper. Such figure may be printed, or may be a letter or a predetermined pattern that is electronically displayed with LEDs, for example. In the latter case, if two or more cameras have captured similar information and it is difficult for the host device 3 to detect the order of the viewpoint of the cameras, the pattern of the displayed marker member 4a can be changed according to an instruction from the host device 3.

The present invention may be implemented as a method for identifying multiple cameras set at different positions along the same plane toward a subject, wherein images of the marker member, which present different shapes depending on the positions of the cameras, are acquired by the respective cameras, and each camera is identified based on the differences of the shape of the marker member captured in these images.

It should be understood that the camera position recognition system of the invention is not limited to those disclosed in the above-described embodiments, and various changes and modifications can be made without departing from the spirit and scope of the invention.

According to the camera position recognition system of the invention, the marker member, which is photographed by the multiple cameras from different viewpoints along the horizontal direction, presents different shapes in images photographed by the cameras depending on the position of each camera. Therefore, relative positions of the cameras can be recognized based on the differences between the shapes of the marker member in the respective images. The host device acquires the images of the marker member photographed by the cameras, and determines camera identification information to be assigned to each camera representing a relative position of the camera based on differences between the shapes of the marker member captured in the images.

In this manner, positions of the cameras can easily and reliably be recognized by placing the marker member in the fields of view of the cameras. Therefore, the host device no longer needs to check the positional order of the acquired images, and this facilitates generation of a 3D image.

What is claimed is:

1. A camera position recognition system comprising:
a plurality of cameras removably placed at different positions to be able to photograph a subject from different viewpoints along a horizontal direction;
a host device to assign camera identification information to each camera, the camera identification information representing a relative position of each camera; and
a marker member placed at a position of the subject and to be photographed by the cameras,
wherein the marker member presents different shapes in images photographed by the cameras depending on the position of each camera, and
the host device acquires the images of the marker member photographed by the cameras and determines the camera identification information based on differences between the shapes of the marker member captured in the images.

2. The camera position recognition system as claimed in claim 1, wherein the marker member comprises right and left ends perpendicular to the horizontal direction, and the host device determines the camera identification information based on values of length ratios of vertical lengths of the right and left ends of the marker member in the images photographed by the cameras.

3. The camera position recognition system as claimed in claim 2, wherein the host device determines identification information specifying a main camera among the cameras, the main camera being one of the cameras that has photographed an image with a length ratio of the vertical lengths of the right and left ends that is nearest to an average of the values of the length ratios in the images of the marker member photographed by the cameras.

4. The camera position recognition system as claimed in claim 1, wherein the marker member comprises a portion with a largest or smallest vertical length in addition to the right and left ends in the horizontal direction, and the host device determines the camera identification information based on values of distance ratios of distances from the right and left ends of the marker member to the portion with the largest or smallest vertical length in the images photographed by the cameras.

5. The camera position recognition system as claimed in claim 4, wherein the host device determines identification information specifying a main camera among the cameras, the main camera being one of the cameras that has photographed an image with a distance ratio that is nearest to an average of the values of the distance ratios in the images of the marker member photographed by the cameras.
